(19) United States
(12) Patent Application Publication
(10) Pub. No.: US 2026/0057392 A1
(43) Pub. Date: Feb. 26, 2026

(54) OPTIMIZING PRODUCT RECALL PROCESSES BASED ON CONSIGNEE DATABASE

(71) Applicant: Honeywell International Inc., Charlotte, NC (US)

(72) Inventors: Ankit Singh, Apex, NC (US); Lakshminarayana Paila, Frisco, TX (US); Waad Subber, Schenectady, NY (US); Zillery Fortner, Florence, KY (US)

(21) Appl. No.: 18/814,625

(22) Filed: Aug. 26, 2024

(51) Int. Cl. G06Q 30/014

(52) U.S. Cl. CPC G06Q 30/014

(57) ABSTRACT

Example techniques to manage recall of a product are described. In an example, data from a consignee database associated with a manufacturer of the product is retrieved. Duplicate records are identified, and single or multiple unique representatives associated with each consignee is identified. Where a single representative is identified, a recall notification is delivered to the single representative. For consignees with multiple representatives, one representative is selected. A notification of recall of the product is provided to the selected representative.

### BACKGROUND

A wide variety of products, including medical devices, consumable items, automotive, toys, food products, pharmaceuticals, and various types of equipment, are manufactured for release into a consumer market. These products are designed to serve various purposes and are expected to meet safety standards for use by consumers. Manufacturing processes for these products typically involve several stages, including production, testing, and post-manufacturing activities, such as packaging and distribution. To ensure a predefined quality of a product, each activity within these stages is carried out in accordance with standard operating procedures (SOPs).

Despite precautions, there may be instances where the products are discovered to be unsafe after they have been made available to consumers. Such safety concerns may arise from design oversights, production anomalies, or inadvertent use of harmful substances. Additionally, the products that were compliant with regulatory standards when initially made available in the market may become non-compliant due to changes in regulations or newly discovered risks. When faced with these issues, manufacturers of the products may be responsible for taking corrective action, which may include initiating a voluntary recall or complying with a recall mandated by regulatory authorities.

Recall process of the affected products may be complex, requiring communication with stakeholders, including consignees, to return affected products, coordination for product returns, information dissemination, and consumer support. The financial and operational costs may be substantial, including recall execution, refunds, and compensation. Also, a recall decision may have lasting impacts on the reputation of the manufacturer of the products to be recalled and on consumer trust. Therefore, it is important to manage the recall in accordance with appropriate predefined processes that comply with regulatory requirements and optimize communication efficiency. Product Recall Management Systems (PRMS) may be employed by the manufacturers to effectively manage the product recall process, streamline communications, and ensure compliance with regulatory requirements.

### SUMMARY

The details of some embodiments of the invention described in this specification are set forth in the accompanying drawings and the description below. Other features, aspects, and advantages of the invention will become apparent from the description, the drawings, and the claims.

The present subject matter relates to methods, systems, and non-transitory computer-readable media for optimizing product recall processes based on consignee data.

In accordance with an embodiment of the present subject matter, a product recall management system (PRMS) includes a recall decision sub-system, a recall execution sub-system, and a consignee database. The consignee database comprises representative data indicative of identification of one or more representatives of a consignee associated with a manufacturer of a product. The recall-execution sub-system is configured to execute a workflow for a process of executing recall of the product. To initiate the process of executing recall of the product, the recall-execution sub-system retrieves representative data from the consignee database and determines if a single or multiple representatives are associated with the consignee. On identifying a single representative to be associated with the consignee, the recall execution sub-system delivers a notification of recall of the product to the single representative. Further, on identifying multiple representatives to be associated with the consignee, the recall execution sub-system selects one representative from amongst the multiple representatives and delivers the notification of the recall of the product to the one representative.

In accordance with another aspect of the present invention, the method is implemented within a PRMS that includes a system configured to execute specific workflows related to recall of products. The method comprises receiving, by the PRMS, instructions to initiate a recall process to recall a batch of products. Upon receiving these instructions, the method further comprises retrieving representative data from a consignee database. This database contains information pertaining to the dispatch of consignments containing one or more of the batch of products by a manufacturer of the products to consignees. The representative data is indicative of the identification of a representative for each consignee. The method then involves identifying, from amongst the consignees, at least one consignee that has received multiple consignments. For this identified consignee, the method comprises analyzing the representative data to identify a representative corresponding to each of the multiple consignments. If the analysis reveals more than one representative associated with the identified consignee, the method further comprises causing a notification of the recall process to be transmitted to one representative from amongst the multiple representatives associated with that consignee.

In accordance with an embodiment of the present invention, the non-transitory computer-readable medium contains instructions that enable a processing resource to receive a request to recall products delivered to a consignee. In an example, the instructions are executable to obtain, from a consignee database, data pertaining to one or more representatives of the consignee. In an example, the instructions are executable to remove duplication in the data to identify at least one unique representative associated with the consignee. In an example, the instructions are executable to provide a notification of the recall of the products to a representative selected from the at least one unique representative associated with the consignee. The processing resource may be part of a system, which may be a recall execution sub-system within a larger recall management system that also includes a recall decision sub-system.

As per the embodiments of the present subject matter, the PRMS enables efficient identification and communication with appropriate representatives of consignees. The recall execution sub-system is configured to analyse the representative data and determine whether single or multiple representatives are associated with a consignee.

The present subject matter thus facilitates streamlined communication in the recall process by selecting a single representative when multiple representatives are associated with a consignee. As the system identifies and notifies the appropriate representative, the overall product recall process is not just expedited but also made more efficient by reducing redundant communications and potential oversights in product recall.

Additional features and advantages are realized through the concepts of the present invention, including improved recall management, reduced delays, and enhanced communication efficiency. Other embodiments and aspects of the invention are described in detail herein and are considered a part of the claimed invention.

### BRIEF DESCRIPTION OF FIGURES

The following detailed description references the drawings, wherein:

FIG. 1 illustrates a network environment for implementing example techniques for optimizing product recall processes based on consignee and representative data, in accordance with an example implementation of the present subject matter;

FIG. 2 illustrates a product recall management system for optimizing the product recall processes based on the consignee and representative data, in accordance with an example implementation of the present subject matter;

FIG. 3 illustrates the product recall management system for optimizing the product recall processes based on the consignee and representative data, in accordance with another example implementation of the present subject matter;

FIG. 4 is a graphical user interface of the product recall management system, in accordance with an example implementation of the present subject matter;

FIG. 5 illustrates a method for product recall management, in accordance with an example implementation of the present subject matter;

FIG. 6 illustrates a flow diagram of a process for notifying a representative of a consignee regarding recall of a product in the product recall management system, in accordance with an example implementation of the present subject matter;

FIG. 7 illustrates a flow diagram of a process for identifying unique consignees based on multiple records of consignees in the product recall management system, in accordance with an example implementation of the present subject matter;

FIG. 8 illustrates a flow diagram of a process for identifying unique representatives based on multiple records of representatives for a consignee in the product recall management system, in accordance with an example implementation of the present subject matter; and

FIG. 9 illustrates a computing environment for managing product recalls, in accordance with an example implementation of the present subject matter.

In the figures, the left-most digits of a reference number identify the figure in which the reference number first appears. The same numbers are used throughout the drawings to reference like features and components.

### DETAILED DESCRIPTION

As discussed above, a product or batches of products may be subject to a recall by a manufacturer for various reasons, including identification of safety concerns or product anomalies that may harm consumers or expose the manufacturer to legal liability. Occasionally, recalls are initiated also due to changes in regulations, leading to non-compliance with previously compliant products. The purpose of the recall is to address these issues by withdrawing affected products from a market or by rectifying an identified anomaly.

Manufacturers rely on product recall management systems (PRMSs) to facilitate a recall process. The PRMSs are specialized tools designed to streamline the process of recalling a product or batches of products from the market. Typically, a PRMS comprises two primary sub-systems: a recall decision sub-system and a recall execution sub-system. The recall decision sub-system is tasked with an initial phase of deciding whether to initiate a recall for a product or batches of products. Further, the recall decision sub-system employs workflows that provide means to collect data, conduct risk analyses, and support decision-making vis à vis the recall of the product. The recall execution sub-system, on the other hand, is configured to implement the execution of the recall once a decision has been made, providing the workflow and tools to do so.

When a complaint regarding an anomaly in a product is received, for example, from a consumer of the product, or through internal quality monitoring processes at manufacturing locations, a user at the end of the manufacturer may issue a request for an investigation of the product to the recall decision sub-system. The investigation, often referred to as risk investigation, aims to assess the validity of the anomaly, severity, and scope of the anomaly in the product that prompted the request regarding the recall of the product to be raised. The risk investigation may involve gathering inputs from users, vendors, and other stakeholders and analysing data, such as customer complaints, and safety concerns related to the reported anomaly. The goal is to determine whether the anomaly poses a risk to consumers and if the anomaly warrants a recall of the product. Based on the risk investigation, if a decision to recall the product is made, in other words, the request for the recall of the product is approved at the recall decision sub-system, and a request for execution of the recall of the product is sent to the recall execution sub-system.

The recall execution sub-system provides for performing the steps necessary for the recall of the product. This includes notifying all stakeholders, managing the logistics of product returns, handling the affected products, maintaining accurate records of the recall process, and providing customer support. The workflow executed in the recall execution sub-system to carry out the recall of the product needs to ensure compliance with regulatory requirements, such as compiling reports on the progress of the recall process and outcomes allowing assessment of the effectiveness of the recall.

When the manufacturer initiates the recall process at the recall execution sub-system, as a first step, a notification of the recall is required to be sent out to the relevant stakeholders comprising consignees. Consignees may be understood as the first set of recipients to whom the product manufactured by the manufacturer is delivered. Such consignees may be, for example, consumers of the product manufactured by the manufacturer, or transporters or distributors associated with the manufacturer who may be responsible for making the product accessible to the consumers of the product.

Each consignee may have one or more representatives associated with it. For instance, a manufacturer of pharmaceutical products, such as a medicinal composition sold in the form of tablets, may manufacture a batch of 100,000 pellets of said tablets. The batch of product, upon manufacturing and packaging, may be delivered to over hundreds of consignees, often in multiple shipments. Each shipment may be addressed to a different addressee or representative associated with the respective consignees. For example, if the consignee is a hospital, the shipments from the manufacturer's end may be addressed to different doctors and administrative staff of the hospital.

Records relating to the consignees and their corresponding recipients or representatives are difficult to maintain because the delivery of a given order from a particular consignee may involve multiple consignments made to different locations and different personnel at the end of the particular consignee. The situation gets particularly complex when consignments are made by different manufacturing sites of the manufacturer. For example, referring to the above-mentioned pharmaceutical products, a proprietor of a chain of pharmaceutical stores may place a significantly large order for purchase of the tablets. The manufacturer may manufacture the tablets at several of its manufacturing sites to fulfill the order and ship out batches of the tablets, as and when they get ready, to multiple retail stores of the proprietor. Each such consignment of tablets may be addressed to a different representative of the consignee, such as a manager or administrative staff at each of the multiple retail stores of the proprietor.

A consignee database is maintained by the manufacturer to record and maintain details of each of the consignees. However, owing to the complexities in recording and maintaining details of the consignments, more often than not, the consignee database contains redundant and inconsistent data with respect to the consignees. Particularly, there may be numerous instances of duplication of data in the consignee database. For instance, there may exist multiple records corresponding to a particular consignee and its representatives owing to reasons such as minor differences in details or attributes of the data. For example, a consignment to consignee A may be addressed to a representative of the consignee A, namely, Mr. John Doe. Another consignment to the same consignee A may be addressed to Mr. J. Doe, and yet another to Mr. John D. Although there is only a single representative of the consignee A in the present example, these discrepancies in the data of the representative of the consignee A, i.e., discrepancies in the name of the representative of the consignee, may incorrectly suggest multiple representatives. Identification and correction of such discrepancies in the data to remove duplication require manual intervention, which consumes time, and effort and is yet prone to human error. Thus, while the consignee database may have records of consignments to various consignees, it often fails to uniquely and accurately identify each consignee and its representative(s).

These data discrepancies can significantly complicate the recall process. For example, in the case of Mr. John Doe, the recall notification might be sent three times to what the system perceives as three different representatives. This redundancy not only wastes resources but could also lead to confusion at the consignee's end. The hospital might receive multiple notifications, potentially causing uncertainty about whether each notification refers to a different batch of products or if they are duplicates. This confusion could delay the hospital's response to the recall, potentially putting patients at risk if the recalled product is a critical medication or medical device.

Moreover, if the recall execution sub-system attempts to track responses from consignees, the presence of these duplicate records could lead to incomplete or inaccurate tracking. The system might erroneously conclude that only one-third of the notifications have been acknowledged when in reality, all notifications pertain to the same representative who has already responded.

Therefore, the identification of each consignee and its representative is crucial to the effectiveness of the recall execution process. This is because the notification of the recall needs to be acted upon by the respective consignees. For example, the notification may be accompanied by an electronic form to be completed on behalf of the respective consignees. If the notification is delivered to multiple representatives corresponding to each consignee, it not only introduces redundancy in the recall execution process but also hampers the effectiveness of the overall recall.

To elaborate by way of an illustration, an example of a recall process initiated to recall 1000 defective products delivered to a distributor, namely, consignee 1 may be considered. The 1000 products may have been delivered in multiple shipments addressed to representative A and representative B associated with consignee 1, who may, for example, be co-owners of consignee 1. The notification may inform the representatives that the 1000 products delivered to consignee 1 are being recalled along with the reasons for said recall. The accompanying electronic form may inquire about the number of products, out of the originally delivered 1000 products, that may be expected to be returned. In a situation where, say, 500 products may have been distributed by the consignee 1 and may not be recalled, 500 products may be expected to be returned, resulting in a recall effectiveness of 50%. However, if the notification is delivered to both the representatives, namely, representative A and representative B, both may independently respond to the electronic form on behalf of consignee 1, indicating that 500 out of the 1000 products are available for return. Not only does notifying both representatives lead to a discrepancy in data that may be subsequently used to track the products being recalled, but it may also lead to the recall effectiveness being incorrectly estimated as 100%.

It is important that the effectiveness of the recall process be accurately captured as this information may also be subject to regulatory reviews. However, as mentioned above, the consignee databases generally maintained by manufacturers to record and maintain details of consignments, sometimes along with other related details like order and payment information, may not be reliable for accurately assessing recall effectiveness as they fail to identify each consignee uniquely.

While there exist sophisticated systems that can track a product at every step of its supply chain, for instance, to determine if the product is in a warehouse, in transit, or a retail store, and enable identification of each stakeholder including each consignee uniquely, these systems are very resource intensive and cost-ineffective. One example of such a system is the Honeywell Track and Trace. While these systems allow manufacturers to track and manage the movement of goods effectively by providing visibility into data related to the movement and status of products, they often have constraints like compliance with certain standards, for example, GS1 Electronic Product Code Information Services (EPCIS) standards. It may not be feasible for all manufacturers, for example, small and mid-size manufacturers, to adapt such systems for managing their recall processes. The constraints for adopting such systems are not only cost-related but often involve technical considerations. For instance, adapting to these relatively new standards for recording and maintaining data in the consignee database may result in the recall management system becoming incompatible with other legacy software systems that the manufacturer may be using for processes ancillary to manufacturing.

According to example implementations of the present subject matter, techniques that enable the system to optimize the product recall process based on the consignee's data in order to identify a unique representative for each consignee associated with a product recall are described. These techniques may help streamline the recall process by reducing redundant communications and improving the accuracy of recall effectiveness assessments.

In accordance with example embodiments of the present subject matter, a PRMS may enable a user of the PRMS to initiate a recall execution for a product identified for the recall, for example, based on determining if a single or multiple representatives are associated with a consignee of the product to be recalled.

In an embodiment, the PRMS may comprise a consignee database. The consignee database comprises representative data indicative of identification of one or more representatives of a consignee associated with a manufacturer of a product, for example, the product identified for the recall. The representative data may include various attributes such as names, contact information, addresses, emails, and designations of the representatives. In some respects, the consignee database may also store information about the consignments delivered to each consignee, including details such as product types, quantities, and delivery dates. In an example, the consignee database may be regularly updated to reflect changes in representative information or to add new consignees and their associated representatives.

Further, in an embodiment, the PRMS comprises a recall execution sub-system configured to execute a workflow for a process of executing the recall of the product. The recall execution sub-system may be configured to initiate and manage various steps involved in the recall process. In some respects, the workflow may include steps such as getting input on the product identified for the recall, generating and sending recall notifications to the consignees, tracking responses from the consignees, managing product returns, documenting the entire recall process, measuring the effectiveness of the recall process for regulatory purposes.

Further, in example embodiments, to initiate the process of executing the recall of the product, the recall execution sub-system may retrieve representative data from the consignee database. In an example, the recall execution sub-system may analyze this data to determine if a single representative or multiple representatives are associated with a particular consignee.

In an example implementation, upon analyzing the representative data, if the recall execution sub-system determines that a single representative is associated with the consignee, it may proceed to deliver a notification of recall of the product to this single representative. The notification may be generated automatically by the recall execution sub-system and may include pertinent details about the recall, such as the product information, reason for the recall, and instructions for next steps. In an example, the recall execution sub-system may offer multiple communication channels for delivering the notification, such as email, SMS, or through a dedicated portal.

In an example implementation, where the recall execution sub-system identifies multiple representatives associated with a consignee, the recall execution sub-system may employ a selection process to determine which representative should receive the recall notification among the multiple representatives. This selection process may be based on various factors, such as the representative's role within the consignee organization, their history of handling previous recalls, or their level of involvement with the specific product being recalled. Once a representative is selected, the recall execution sub-system may proceed to deliver the notification of the recall to this chosen representative.

Also, after the recall execution sub-system selects one representative from amongst the multiple representatives associated with the consignee, the recall execution sub-system may provide an indication of this selected representative to the recall decision sub-system. This information may be used by the recall decision sub-system to maintain a record of the recall process, including which specific representatives were notified for each consignee.

The present subject matter thus incorporates an intelligent PRMS for optimizing the recall process by efficiently identifying and communicating with appropriate representatives of consignees. This PRMS may analyze representative data to determine if a single or multiple representatives are associated with each consignee. In cases where multiple representatives are identified for a consignee, the PRMS may select one representative to receive the recall notification, potentially reducing redundant communications and minimizing confusion. This approach may serve to create a more efficient recall process, ensuring that critical information reaches the appropriate point of contact in a timely manner. The ability of the PMRS to identify unique representatives for each consignee may also contribute to more accurate tracking of recall responses and assessment of recall effectiveness, which may be valuable for regulatory compliance and future recall management strategies.

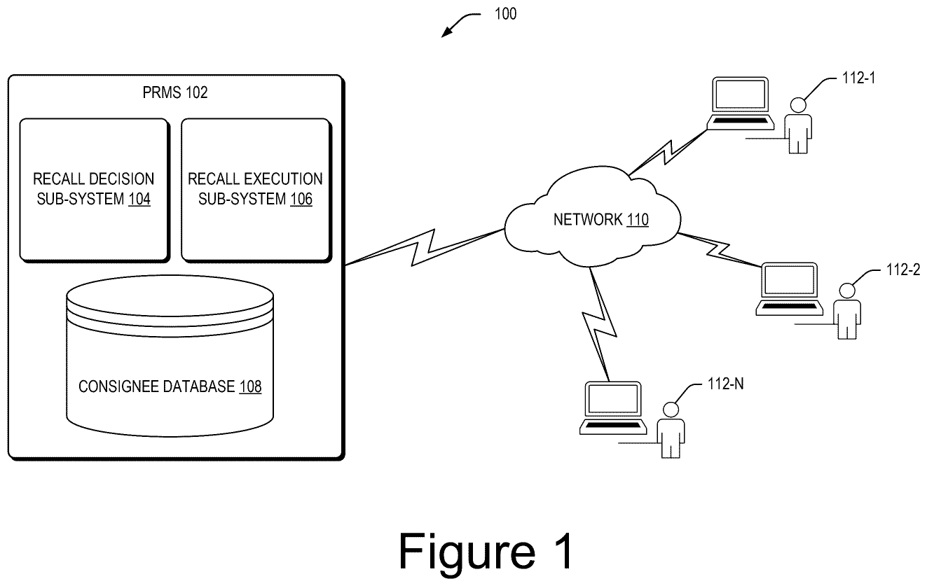

The above techniques are further described with reference to FIG. 1 to FIG. 10. It should be noted that the description and the Figures merely illustrate the principles of the present invention along with examples described herein and should not be construed as a limitation to the present invention. It is thus understood that various arrangements may be devised that, although not explicitly described or shown herein, embody the principles of the present invention. Moreover, all statements herein reciting principles, aspects, and implementations of the present invention, as well as specific examples thereof, are intended to encompass equivalents thereof.

FIG. 1 illustrates a network environment 100 for implementing example techniques for optimizing product recall processes based on consignee and representative data, in accordance with an example implementation of the present subject matter.

Recall processes are implemented in various industries, such as automotive, pharmaceuticals, consumer goods, electronics, and food production, to ensure consumer safety and compliance with regulatory standards. The recall process may be initiated due to various reasons, including but not limited to, safety concerns that pose risks to consumers, product performance issues that do not meet specifications (such as functionality or durability problems) of manufacturer, potential contamination in food or pharmaceutical products, use of substandard materials in the manufacturing process, or newly discovered adverse effects in medical devices or drugs. In some instances, recalls may be precautionary measures taken in response to potential risks identified through post-market surveillance, even if no adverse events have been reported. Regulatory bodies may also mandate recalls based on their own investigations or reports from consumers, healthcare providers, or other stakeholders in the supply chain.

The recall processes often address additional requirements, such as timely response and minimization of negative impact on the reputation of a manufacturer and finances. As products that may be recalled are designed for a wide variety of uses, the criteria and urgency for recalls vary considerably to cater to the respective safety and compliance concerns associated with each type of product. Product recall management systems are tools used to streamline the recall process for recalling products that are found to be defective, for example, due to an anomaly, or non-compliance with regulatory guidelines. In many cases, these systems are designed to align with and enforce standard operating procedures (SOPs) specific to recall processes. SOPs may outline step-by-step instructions for initiating, executing, and documenting recalls, ensuring consistency and compliance across different recall scenarios.

In an example implementation of the present subject matter, the network environment 100 comprises a product recall management system (PRMS) 102. In an embodiment, the PRMS 102 may be implemented and operated by a manufacturer of a product to manage instances of recall of the product manufactured by the manufacturer.

The PRMS 102 comprises two primary sub-systems: a recall decision sub-system 104 and a recall execution sub-system 106. The recall decision sub-system 104 serves as a central repository for all information pertinent to a product or batches of products that may be subject to recall. The recall decision sub-system 104 provides workflows implementing processes for the collection, updating, and maintenance of predefined information related to the product, which is a prerequisite for any recall action to be taken. An example of a workflow implemented in the recall decision sub-system 104 for collection of information related to the product may comprise steps of collecting complaint reports relating to the product from consignees. The recall decision sub-system 104 may include tools, for example, data analytics tools to analyze the complaint reports to extract pertinent information related to the product. These tools, as will be understood, also comprise user interfaces that may present data to users and receive user inputs. In an example, based on the analysis of the collected data, risk assessments, and regulatory requirements, the recall decision sub-system 104 facilitates the decision-making process to determine whether a recall is necessary. If it is determined that a recall is necessary, the recall decision sub-system 104 may notify the recall execution sub-system 106 to execute the recall process. The recall decision sub-system 104 may further include one or more databases, for example, to store data relating to the workflows and processes implemented in the recall decision sub-system 104, as well as historical recall data and decision outcomes to inform future recall decisions.

The recall execution sub-system 106 implements processes for recall execution. An example of a workflow implemented by the recall execution sub-system 106 may be a process of notifying stakeholders of a decision to recall the product. The process of notifying may comprise, for example, retrieving contact information of the stakeholders to whom the notification needs to be provided from a database associated with the recall management system. Further processes may include creation of an electronic form bearing information relating to the product and questions to which inputs from the stakeholder may be requested. The recall execution sub-system 106 may also manage the distribution of these notifications, track responses, coordinate the return or disposal of recalled products, and generate reports on the progress and effectiveness of the recall process.

Although the recall decision sub-system 104 and the recall execution sub-system 106 generally work in tandem in deciding the recall and executing the recall process of any product, in some implementations, the recall execution sub-system 106 may also work independently, without the recall decision sub-system 104. For example, this may occur in cases where the recall decision is taken outside the PRMS 102, such as based on a mandate from regulatory authorities or through external processes not managed within the system 102. In such scenarios, the recall execution sub-system 106 may be activated directly to implement the recall execution process, bypassing the decision-making phase typically handled by the recall decision sub-system 104.

In an example implementation of the present subject matter, the PRMS 102 may include a consignee database 108. The consignee database 108 may be implemented and maintained by the manufacturer of the products to serve as a repository for data related to distribution of the products manufactured by the manufacturer. The manufacturer may record information about the dispatch of the products from a site of manufacturing to any external location in the consignee database 108. The consignee database 108 may be configured to maintain a comprehensive and up-to-date record of all product distributions, including consignee data, product information, shipment details, and representative data.

In an embodiment, the consignee database 108 may comprise detailed information about product shipments and consignees, such as the name and contact information (email, phone number, address) of the receiving consignee, quantity of products in each shipment, batch numbers, lot numbers, shipping dates, and quantities dispatched. In another embodiment, the consignee database 108 may also store details of representatives associated with each consignee. For example, in the case of pharmaceutical products, this may include records of shipments made to individuals, hospitals, and pharmacies as consignees, along with their respective addresses, locations, and other contact details. The consignee database 108 may be regularly updated to ensure the accuracy and completeness of the stored information.

The ‘consignees’ in this context may refer to the recipients or customers who receive the shipments of the products from the manufacturer, either directly or indirectly. These may include various entities such as distributors, retailers, facilities, or individual consumers, depending on the industry and distribution model. Each consignee may have one or more representatives who are authorized to receive consignments of products and communications related to the products from the manufacturer. For example, a hospital may have a procurement officer as well as several pharmacists who may be the designated representatives for receiving consignments of products and communications related to the products from the manufacturer. The consignee database 108 may also store information about these representatives, such as their names, job titles, contact details, and specific roles within the consignee, in cases where the consignee is an organization.

In some implementations, the consignee database 108 may also track the history of communications with each representative, including past recall notifications and responses. The PRMS 102 may be configured to handle changes in representative information, such as when a new representative is appointed or when contact details of a representative are revised. The PRMS 102 may incorporate mechanisms for updating information pertaining to the consignees. Various techniques may be used for the purposes of handling such updates. In an example, the information may be input to the PRMS 102 by a user. The PRMS 102 may provide a user interface, for example, a webpage or an electronic form that may be used by the user or the representatives to provide updates to the PRMS 102. The consignee database 108 may also be configured to allow for querying and retrieval of information based on various parameters, such as product type, consignee type, geographical location, or date range.

Though not shown in the example implementation depicted in FIG. 1, the consignee database 108 may reside external to the PRMS 102. Thus, example implementations where the data stored in the consignee database 108 is in an external database accessible by the PRMS 102 are also possible. The external database may be accessed by the PRMS 102 through a network 110. In an example, the network 110 may be a single network or a combination of multiple networks and may use a variety of different communication protocols. The network 110 may be a wireless or a wired network, or a combination thereof. Examples of such individual networks include, but are not limited to, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NON), Public Switched Telephone Network (PSTN). Depending on the technology, the network 110 includes various network entities, such as gateways, and routers; however, such details have been omitted for the sake of brevity of the present description.

In certain cases, one or more products manufactured by the manufacturer and dispatched from a site of manufacturing may need to be recalled. For example, based on execution of the workflows defined in the recall decision sub-system 104, the recall decision sub-system 104 may decide to recall the products. Based on the decision by the recall decision sub-system 104, a notification to execute the recall may be sent to the recall execution sub-system 106 of the PRMS 102. For the purposes of executing the recall of the products that have been dispatched from the site of manufacturing, the recall execution sub-system 106 may rely on information available in the consignee database 108.

Accordingly, when initiating a recall process, the recall execution sub-system 106 may retrieve consignee data from the consignee database 108. In accordance with example implementations of the present subject matter, the recall execution sub-system 106 may analyze this data to determine if a single or multiple representatives are associated with each of the consignees from whom the products are to be recalled. Upon analyzing the consignee data and the representative data from the consignee database 108, if the recall execution sub-system 106 determines that a single representative is associated with a unique consignee, the recall execution sub-system 106 may proceed to deliver a notification regarding the recall of the product marked for the recall to this single representative. In cases where multiple representatives are identified for a unique consignee, the recall execution sub-system 106 may select one representative from amongst the multiple representatives to receive the notification regarding the recall of the product.

In an embodiment, the notification regarding the recall of the product may be provided to a unique representative of each of the consignees via user devices 112-1, 112-2, . . . , 112-N of the respective representatives. The PRMS 102 may be communicatively coupled with the user devices 112-1, 112-2, . . . , 112-N over the network 110 to deliver the notification. The PRMS 102 may utilize various communication channels, such as email, SMS, or a dedicated portal to deliver these notifications to the respective consignees of the product for which the recall execution process has been initiated at the recall execution sub-system 106.

In some embodiments, the channel of communication between the user devices 112-1, 112-2, . . . , 112-N and the PRMS 102 may be based on various considerations, such as the contact information of the consignee available in the consignee database 108, the consignee type, or the consignee's preference. For example, for a given consignee, if a phone number alone and no email ID is recorded in the consignee database 108, the channel of communication may be an SMS. In another example, if the consignee type is an organization and not an individual, a more formal channel of communication, such as an email may be preferred over an SMS.

In an example, the notification generated by the PRMS 102 may include pertinent details about the recall, such as the product information, reason for the recall, and instructions for next steps. The notification invites action by the representatives on behalf of the respective consignees. In accordance with example implementations of the present subject matter, based on the analysis of the consignee data performed at recall execution sub-system 106, the notification of recall of the products is provided to a unique representative of each of the consignees by the PRMS 102. Hence, only a single representative is called upon to act upon the notification on behalf of each of the consignees.

Thus, the present subject matter optimizes the product recall processes by effectively identifying and communicating with appropriate representatives of consignees. This is achieved by analyzing the representative data to determine if single or multiple representatives are associated with each consignee, ensuring targeted and effective communication. In cases of multiple representatives, the recall execution sub-system 106 of the PRMS 102 allows for selecting a single representative to receive the recall notification, thereby improving the accuracy of tracking recall responses from the affected consignees. This not only streamlines the recall process but also enhances the efficiency and effectiveness of the product recall management.

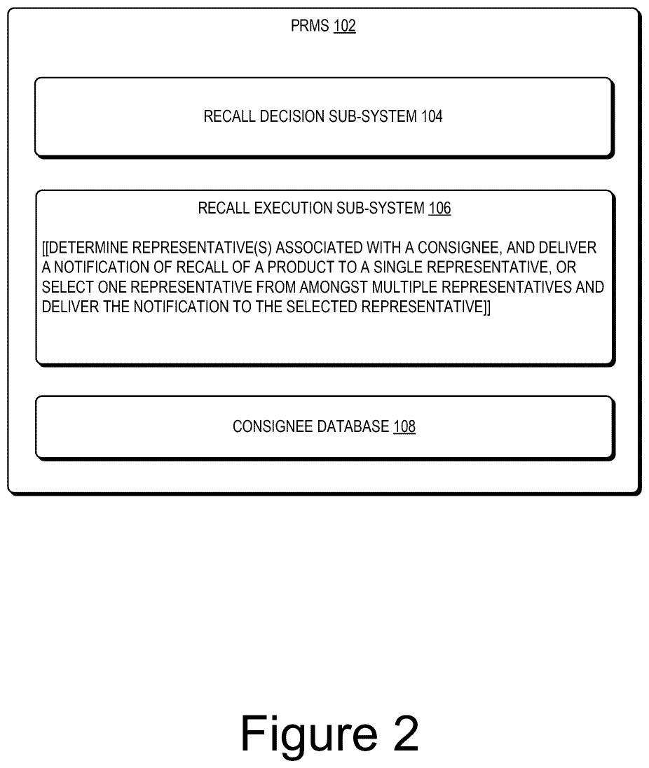

FIG. 2 illustrates the PRMS 102 to optimize the recall process of a product or batches of products based on consignee data, in accordance with an example implementation of the present subject matter.

As explained previously, manufacturer of a product may need to recall the product due to identified anomalies, regulatory compliance, or precautionary measures based on potential risks. Product recall management systems, such as the PRMS 102, are generally used to streamline the process of recalling the product. The PRMS may be designed to align with and enforce SOPs specific to recalls, ensuring consistency and compliance across different scenarios.

As explained previously, the PRMS 102 may include two sub-systems: the recall decision sub-system 104 and the recall execution sub-system 106. The recall decision sub-system 104 is responsible for assessing risks and determining whether a recall is necessary. The recall decision sub-system 104 analyzes data, evaluates potential hazards, and makes recommendations on whether to initiate a recall. The recall execution sub-system 106 manages the actual implementation of a recall once it has been decided. In some embodiments, the inclusion of the recall decision sub-system 104 in the PRMS 102 may be optional and the PRMS 102 may operate with only the recall execution sub-system 106. This configuration is useful in cases where the decision to recall a product is made outside the PRMS 102. For example, a recall may be initiated based on consumer complaints or regulatory mandates without going through a decision process. In such cases, the recall decision is given directly to the recall execution sub-system 106 to begin the recall process.

In an example embodiment of the present subject matter, once the decision to recall the product is taken either through the recall decision sub-system 104 of the PRMS 102 or outside the PRMS 102, an authorized user of the recall execution sub-system 106 may be notified to start the process of recalling the product. First step towards recalling the product may include notifying, by the PRMS 102, various consignees of the product so that they can return the product. In an example, the notification may be delivered through various means, including, but not limited to, email, SMS, and voice notes. As explained previously, to ensure that the recall process is efficient, sending multiple notifications to what is effectively the same consignee is avoided. This is achieved by ensuring that each consignee to whom the product has been shipped is uniquely identified before sending out the notification.

In doing so, according to an example implementation of the present subject matter, the recall execution sub-system 106 may communicate with the consignee database 108 to retrieve representative data. The representative data may be indicative of identification of one or more representatives of a consignee associated with a manufacturer of the product. Based on the representative data, the recall execution sub-system 106 determines if a single or multiple representatives are associated with the consignee. If the recall execution sub-system 106 identifies that a single representative is associated with the consignee, the recall execution sub-system 106 may deliver a notification regarding the recall of the product to the single representative. In case the recall execution sub-system 106 determines that multiple representatives are associated with the consignee, the recall execution sub-system 106 may select one representative from among the multiple representatives and deliver the notification of the recall of the product to the selected representative.

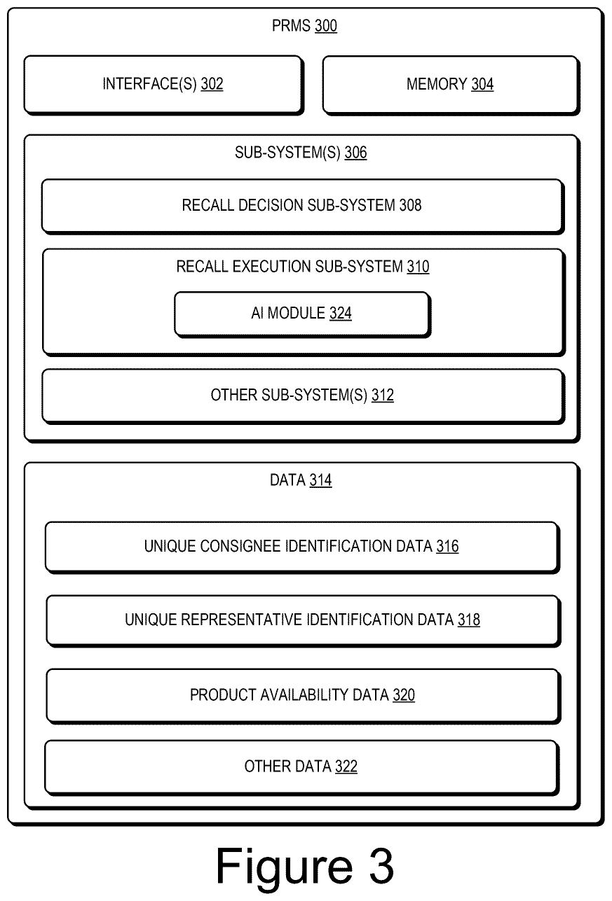

Therefore, the present subject matter allows for sending a single recall notification to a unique representative of each consignee, rather than multiple notifications to the same assignee. This reduces confusion and information overload for the consignees, streamlines the recall process, and improves response tracking. To elaborate on the functionality of the PRMS 100 to optimize the recall process of the product based on the consignee data, reference is made to FIG. 3.

FIG. 3 illustrates a product recall management system (PRMS) 300 that optimizes the process of recalling a product or batches of products based on consignee data, in accordance with an example implementation of the present subject matter.

In an example, the PRMS 300 is similar to the PRMS 100, as explained in reference to FIGS. 1 and 2. In an example, the PRMS 300 depicted in FIG. 3 may be any computing device. Examples of the PRMS 300 may include but are not limited to servers, desktop computers, laptops, smartphones, personal digital assistants (PDAs), and tablets.

The PRMS 300 comprises interface(s) 302. The interface(s) 302 may include a variety of software and hardware interfaces that allow interaction of the PRMS 300 with other communication and computing devices, such as network entities, web servers, external repositories, and peripheral devices, such as input/output (I/O) devices. For example, the interface(s) may couple the PRMS 300 with the consignee database 108 and user devices 112-1, 112-2, . . . , 112-N of representatives of consignees of the product to be recalled. The interface(s) 302 may also enable coupling of internal components, if any, of the PRMS 300 with each other. Further, the PRMS 300 comprises a memory 304. The memory 304 may include any computer-readable medium known in the art including, for example, volatile memory, such as Static Random-Access Memory (SRAM) and Dynamic Random-Access Memory (DRAM), and/or non-volatile memory, such as Read Only Memory (ROM), Erasable Programmable ROMs (EPROMs), flash memories, hard disks, optical disks, and magnetic tapes.

The PRMS 300 further includes sub-system(s) 306 and data 314. The sub-system(s) 306 may be implemented as a combination of hardware and programming, for example, programmable instructions to implement a variety of functionalities of the sub-system(s) 306. In examples described herein, such combinations of hardware and programming may be implemented in several different ways. For example, the programming for the sub-system(s) 306 may be executable instructions. Such instructions in turn may be stored on a non-transitory machine-readable storage medium which may be coupled either directly with the PRMS 300 or indirectly (for example, through networked means).

In an example, the sub-system(s) 306 may include a processing resource, for example, either a single processor or a combination of multiple processors, to execute such instructions. In the present examples, the processor-readable storage medium may store instructions that, when executed by the processing resource, implement the sub-system(s) 306. In other examples, the sub-system(s) 306 may be implemented as electronic circuitry.

The sub-system(s) 306 include a recall decision sub-system 308, a recall execution sub-system 310, and other sub-system(s) 312. In an example, the recall decision sub-system 308 and the recall execution sub-system 310 are similar to the recall decision sub-system 102 and the recall execution sub-system 104, respectively, as explained in reference to FIGS. 1 and 2. The other subsystem(s) 312 may further implement functionalities that supplement applications or functions performed by the PRMS 300 or any of the sub-system(s) 306 of the PRMS 300. The data 314, on the other hand, includes data that is either stored or generated as a result of functionalities implemented by the PRMS 300 or any of the sub-system(s) 306. It may be further noted that information stored and available in the data 314 may be utilized by the sub-system(s) 306 for executing the process of recall of the product, for example, upon identification of an anomaly in the product, by sending a notification regarding the recall of the product to a unique representative of a consignee of the product.

In an example, the data 314 may comprise unique consignee identification data 316, unique representative identification data 318, product availability data 320, and other data 322. The data 314 serves, amongst other things, as a repository for storing data that may be fetched, processed, received, or generated by one or more of the sub-system(s) 306.

In operation, in an example implementation of the present subject matter, a request to recall a product may be received by the recall execution sub-system 310. For the purposes of the present description, any reference made to a product to be recalled may include a single product, a set or batch of a product, or multiple sets or batches of products that have been shipped to one or more consignees. The consignee, in this context, may refer to a party to whom the product is shipped or consigned by the manufacturer, such as a distributor, retailer, or other business partner. The consignee may be a legal entity or a natural person. In case the consignee is a legal entity, for example, a company, the consignee may have representatives whose data may also be available in the consignee database 108. In case the consignee is a natural person, the identification details of such a person are considered consignee data. For example, in the case of pharmaceutical products, the consignee may include end-users, doctors, hospitals, and pharmacies.

In some embodiments, prior to executing the process of the recall of the product, a risk investigation may be conducted at the recall decision sub-system 308 to assess severity and scope of the anomaly. The risk investigation may involve analyzing product quality data, customer complaints, safety reports, and regulatory guidelines. The recall decision sub-system 308 may use this information to determine whether a recall is necessary and, if so, the appropriate scale and urgency of the recall. Based on this determination, the recall decision sub-system 308 may notify the recall execution sub-system 310 to start executing the process of recall of the product. In an alternative embodiment, the recall process may be initiated at the recall execution sub-system 310 based on consumer complaints or regulatory mandates without going through the risk investigation process. In such cases, the recall decision sub-system 308 may be optional, and the PRMS 300 may not invoke or include the recall decision sub-system 308.

Based on the decision to recall the product, the recall execution sub-system 310 may initiate a process of notifying various consignees, to whom the product has been shipped, regarding the recall of the product so that the consignees may return the product to the manufacturer. A first step towards notifying the consignees regarding the recall of the product may include uniquely determining each consignee to whom the product has been shipped. Accordingly, in an example, for the purpose of identifying the unique consignees, the recall execution sub-system 310 may query the consignee database 108 to retrieve the consignee data corresponding to the products to be recalled. In an example, the consignee data may comprise information about all consignees associated with the product to be recalled. In some embodiments, the consignees associated with the product to be recalled may include both consignees who have received the product to be recalled and those who have not. In such cases, consignees associated with the product to be recalled may be filtered out. For example, a pharmaceutical company manufacturing insulin may have the consignee data, stored in the consignee database 108, corresponding to the consignees of the product to be recalled, consignees that may include hospitals, pharmacies, and diabetes clinics. Some of these consignees may have received the specific batch of the insulin that is under recall, while others may have received the insulin from the same pharmaceutical company but of a different batch that is not under recall. Additionally, the consignee database 108 may have information about consignees who have previously ordered the insulin from this pharmaceutical company but did not receive any insulin from the batch under the recall, or consignees who are approved to receive the insulin but have not yet placed an order.

In an embodiment, to determine the unique consignees from amongst the consignees who have received the product to be recalled, the recall execution sub-system 310 may extract attributes associated with the consignees from the consignee data. The attributes of the consignee data may be defined as pieces of information that identify and describe a consignee. In an example, the attributes of the consignee data may include, but are not limited to, product identification number corresponding to the products received by the consignee, quantity of the product to be recalled received by the consignee, date of delivery of such products, and identification details of the consignee comprising details, such as account or identification number of the consignee, name, phone number, email address, and mailing address of the consignee. In an example, data corresponding to each consignee attribute may be populated by the manufacturer, for example, at the time of receiving the request for dispatching the product to the consignee or at the time of sending the product to the consignee. In an example, fields of records of the attributes of the consignee data may be configurable by the manufacturer.

Once the attributes of the consignee data associated with each consignee who has received the product to be recalled are fetched from the consignee database 108, the next step may be to determine duplicate consignees from amongst these consignees. Accordingly, in one embodiment, the recall execution sub-system 310 may implement an artificial intelligence (AI) module 324 that may be configured to determine the duplicate consignees using a fuzzy matching algorithm for similarities in different combinations of the attributes of the consignee data. In an example, the AI module 324 is to determine a degree of similarities in the attributes of the consignee data of each consignee to identify the duplication of the consignees. This process may involve analyzing various attributes of the consignee data and assigning similarity scores to potential matches.

In an example, the AI module 324 may consider the similarities in attributes related to identification details, such as first name, last name, and middle initials. In an example, the AI module 324 may be trained to account for common variations, nicknames, and typographical errors in the name related attributes of the consignee data. For example, “William” and “Billiam” may be recognized by the AI module 324 as potential matches, or “Catherine” and “Katherine” may be identified as similar. The AI module 324 may also identify mailing address related similarities, such as street names, cities, and zip codes. In an example, the AI module 324 may use address standardization to normalize address formats before comparison. For example, the AI module 324 may handle common abbreviations (e.g., “St.” vs. “Street”) and account for minor discrepancies in spelling or formatting of the mailing address. The AI module 324 may also consider hierarchical nature of the mailing addresses, giving more weight to matches in more specific fields like street number and name. Also, the AI module 324 may identify the email address related similarities in attributes of the consignee data, considering domain names, variations, and potential typos. This may involve parsing email addresses into local parts and domains, and then applying separate similarity metrics to each. The AI module 324 may recognize common email patterns (e.g., firstname.lastname@domain.com) and account for usual variations like the inclusion of middle initials or numerical suffixes in the names of the corresponding consignees. In an example, these steps may be performed iteratively to progressively refine the identification of duplicate consignees, with each step filtering out potential matches in the attributes of the consignee data identified in previous steps.

In an example, for each comparison of attributes of the consignee data, the AI/ML module 324 may assign a similarity score, for example, on a scale from 0 to 1, with 1 indicating an exact match. In an example, the attributes to be considered for the similarity comparison may be predefined, for example, based on input from a recall process manager (RPM) who may be a user authorized to process the recall request for the product at the recall execution sub-system 310. These individual similarity scores may then be combined using a weighted average to produce an overall degree of similarity for each potential duplicate pair of consignees. The weights for averaging the similarity scores may be adjusted based on a relative importance of each consignee attribute. For instance, attributes that may serve to specifically identify a unique consignee, like email address or bank account number may be given more weightage. For example, the overall degree of similarity may be calculated as (0.3 name similarity)+ (0.4 address similarity)+ (0.5 email similarity).

In an example, the AI module 324 may use configurable thresholds to categorize potential duplicates in the attributes of the consignee data into high, moderate, and low confidence matches based on their overall degree of similarity. These categories may be defined as high confidence for an overall degree of similarity, for example, greater than 0.9, moderate confidence for the overall degree of similarity greater than 0.7 and less than or equal to 0.9, and low confidence for the overall degree of similarity greater than 0.5 and less than or equal to 0.7. These thresholds may be adjusted to balance precision and recall in duplicate consignee detection and may be updated based on input from the RPM. For example, the consignee data retrieved from the consignee database 108 may have the attributes of the consignee data such as first name, last name, middle initials, email address, area code, phone number, and mailing address, and the data corresponding to these attributes of the consignee data may be according to Table 1 given below:

| First | Last | Middle | Email | Area | Phone | |
|---|---|---|---|---|---|---|
| Name | Name | Initials | Address | Code | Number | Address |
| John | Smith | B | jsmith82@gmail.com, | 865 | 2060407 | 742 Evergreen Terrace, |
| | | | | | | Springfield, OR 97477 |
| Jon | Smith | B | jon.smith@outlook.com | 865 | 2060407 | 742 Evergreen Terrace, |
| | | | | | | Springfield, OR 97477 |
| Johnny | Smith | B | jbsmith@yahoo.com | 865 | 2060407 | 742 Evergreen Terrace, |
| | | | | | | Springfield, OR 97477 |
| John | Doe | A | johndoe123@email.com | 212 | 551234 | 123 Main St, |
| | | | | | | Springfield, IL |
| Emma | Smith | L | emma.smith@company.net | 415 | 2060407 | 1600 Pennsylvania Avenue NW, |
| | | | | | | Washington, DC 20500 |
| Michael | Johnson | N/A | mjohnson@outlook.com | 646 | 5436789 | 350 Fifth Avenue, |
| | | | | | | New York, NY 10118 |
| Sarah | Williams | N | swilliams22@gmail.com | 987 | 6542341 | 1 Infinite Loop, |
| | | | | | | Cupertino, CA 95014 |

Based on the data corresponding to the attributes of the consignee data given in the Table 1, the AI module 324 may identify that the four records likely refer to the same person due to the similarity in names and identical last names. The AI module 324 may further compare other attributes of the consignee data such as middle initials (all B), email addresses (all related to John Smith with variations), identical area codes (865), identical phone numbers (2060407), and identical mailing addresses (742 Evergreen Terrace, Springfield, OR 97477). The AI module 324 may assign high similarity scores to the attributes of the consignee data for these records in the Table 1, resulting in a high overall degree of similarity. Consequently, the AI module 324 may categorize the records in the Table 1 as high confidence matches (overall degree of similarity >0.9), indicating a high likelihood of duplication in the consignee data for John Smith. In an example, the AI module 324 may be trained on known fuzzy matching algorithms for identifying similarities in different attributes of the consignee data. Examples of the fuzzy matching algorithms may include, but are not limited to, Levenshtein distance or Jaccard similarity fuzzy matching algorithms.

Further, based on the degree of similarity between the combinations of these attributes of the consignee data, the AI module 324 may flag that a set of records, for example, the first four records of Table 1 potentially refer to the same consignee. Such flagged records may be processed by a user to merge similar records in some examples. In other examples, the AI module 324 may apply record linkage techniques to compare specific attributes across the flagged consignee records. The AI module 324, for example, may use the attributes of the consignee data, such as the exact match of street names, similarity in name patterns, and the domain of email addresses, and determine that the flagged records, such as the four flagged records of Table 1 indeed represent the same consignee. In some cases, the AI module 324 may seek user inputs to conclude that the flagged records indeed represent the same consignee. The AI module 324 may present these potential matches to the RPM for review. The RPM examines the potential matches and may confirm that all four flagged consignee records in Table 1 indeed represent the same consignee: John B. Smith, living at 742 Evergreen Terrace, Springfield, OR 97477. The AI module 324 may also allow the RPM to select and complete the entry to represent the record as a unique consignee.

In an example, to determine the unique consignee among the potential matches, the RPM may provide input to the AI module 324 by relying on one or more factors including, but not limited to, completeness of information, recency of data, domain reliability of the email address, consistency with other records, and frequency of use. The record with the most complete set of attributes of the consignee data may be preferred, or if timestamp information is available, the most recently updated entry may be chosen. Records with email addresses from an organization's domain (e.g., company email addresses) may be given preference. The data corresponding to the attributes of the consignee data that align most closely with other non-duplicate records in the database may be selected. If transaction history corresponding to the product to be recalled is associated with any of the duplicate consignee records, the entry associated with the most recent or frequent transactions may be chosen. Weights for these factors may be predefined in the PRMS 300, and the AI module 324 may use these predefined weights to calculate a composite score for each duplicate consignee entry, selecting the entry with the highest score as the unique consignee. As the RPM input consolidates these records over time, the AI module 324 may be trained on this data to automatically predict the unique consignee without input from the RPM.

For example, considering the four records for John Smith with variations in name and email addresses but identical contact details as indicated in the Table 1, based on the input from the RPM, the AI module 324 may evaluate the completeness of information (all records being equal in this example), recency of data (favoring the most recently updated entry), email domain reliability (preferring common domains like gmail.com), consistency with usual records (favoring the most common name format “John B. Smith”), and frequency of use (prioritizing records with recent transaction history). By applying weights to these factors and calculating composite scores, the AI module 324 may select “John B. Smith” with the gmail.com address as the unique consignee due to its common name spelling, reliable email domain, and overall consistency with typical database records. The data corresponding to the unique consignees may be stored in the memory 304 of the PRMS 300 as the unique consignee identification data 316 for further processing.

In an example, after determining the unique consignees, the PRMS 300 may allow the AI module 324 to process the duplicate consignees in several ways based on the input from the RPM. In one example, the data corresponding to the attributes of the consignee data available in the duplicate consignee records that are not available in the unique consignee entry may be merged into the unique attributes of the consignee data. Alternatively, based on the input from the RPM, the AI module 324 may choose to dispose of the duplicate consignees by deleting them from the consignee database 108 once the unique consignee has been identified.

Further, as explained previously, consignees may be natural persons who may have received the product to be recalled directly from the manufacturer. In such cases, the recall execution sub-system 310 may send the notification regarding the recall of the product directly to these individuals, in an example. However, in other cases, the unique consignees obtained after removing the duplicate consignees may include legal entities, such as hospitals and pharmacies in case of manufacturers related to medical products, who themselves may not have received the product to be recalled but through their representatives. Thus, in such cases, a similar technique as explained above may be used to remove duplicates in the consignee and representative data. However, even after the removal of the duplicate representatives, there may be more than one representative associated with each unique consignee and it may need to be determined to which representative the notification regarding the recall is to be sent out.

Accordingly, in an example implementation of the present subject matter, the recall execution sub-system 310 extracts representative data from the consignee database 108 for each unique consignee who has received the product to be recalled. In an example, the representative data may comprise information about all possible individuals associated with a unique consignee who is in some way involved in dealing with the product to be recalled. For example, the unique consignee may be a pharmacy where the product to be recalled may have been shipped in multiple consignments. In such cases, multiple representatives may be captured in the consignee database 108 because the pharmacy may operate in shifts, and different consignments of the same product to be recalled may have been received by different individuals at the pharmacy. In that, John Doe, a day shift Manager, may have signed for a consignment on Monday morning, while Jane Smith, a night shift supervisor, may have received another shipment on Tuesday evening. Additionally, Mike Johnson, a weekend pharmacist, may have accepted a consignment of the product to be recalled on Saturday afternoon, and Sarah Brown, an inventory specialist, may have processed the product into a pharmacy stock system. All these individuals are associated with the same unique consignee (the pharmacy) and are involved in handling the recalled product at different stages or times, necessitating their inclusion in the consignee database 108.

In an embodiment, to determine the unique representative from amongst the multiple representatives who may be associated with the consignee in some way, the recall execution sub-system 310 may extract attributes pertaining to each representative associated with the consignee from the representative data. The attributes of the representative data may be defined as pieces of information that identify and describe a representative. In an example, the attributes of the representative data may include, but are not limited to, name, designation, contact information, department, shift timings, frequency of interaction with the product to be recalled, level of authority within the organization, and duration of employment with the unique consignee.

In an example, data corresponding to each representative attribute may be populated by the manufacturer by extracting information from various sources within the consignee database 108. These sources may include, but are not limited to, purchase order records, delivery receipts, electronic communications, customer relationship management (CRM) systems, and historical interaction logs. For example, the name and designation of a representative may be obtained from signed delivery receipts, while contact information may be sourced from a CRM system. Shift timings and department information may be derived from the purchase order records that indicate when and by which department of the consignee the product was ordered. The frequency of interaction with the manufacturer of the product to be recalled may be inferred from historical purchase and usage data, while the level of authority and duration of employment may be extracted from organizational records of the consignee, in some examples. In an example, fields of records corresponding to the attributes of the representative data may be configurable by the manufacturer of the product to be recalled.

Once the representative attributes associated with each unique consignee who has received the product to be recalled are fetched from the consignee database 108, a unique representative from amongst all the representatives is determined. The method of identifying the unique representatives may be similar to identifying the duplicate consignees explained previously. In that, the AI module 324 employs fuzzy matching algorithms to identify potential duplicate representatives based on similarities in name, contact information, job title, and other relevant attributes. After removing duplicates, the AI module 324 calculates a composite score for each remaining representative based on factors such as role relevance, frequency of interaction with the manufacturer, level of authority, and availability. The representative with the highest composite score may be selected as the unique representative for that consignee. In cases where scores are close, multiple representatives may be retained. The AI module 324 may then present the selected unique representatives to the RPM for final review and confirmation.

In an example, the AI module 324 may determine the unique representative among the potential multiple unique representatives based on the input from the RPM. The input from the RPM may be based on one or more factors including, but not limited to, the name of the representative (considering variations and possible typos), contact information (such as phone numbers and email addresses, paying attention to similar domain names or slight variations), mailing address (comparing street names, cities, and zip codes for similarities), designation or job title, department, shift timings, frequency of interaction with the recalled product, level of authority within the organization, and duration of employment with the unique consignee. By comparing these attributes across different representative records, the AI module 324 may identify patterns or similarities that suggest potential duplicates. In cases where the determination is not clear from these attributes, the RPM may confirm the unique representative from among potential multiple unique representatives by directly communicating with the consignee, such as making a phone call or sending an email. The data corresponding to the unique representative may be stored in the memory 304 of the PRMS 300 as the unique representative identification data 318 for further processing. This stored data may be made available for training the AI module 324 to improve future representative selection processes.

Once the unique representative from amongst the multiple potential unique representatives is identified, the notification regarding the recall may be sent to the selected unique representative. Upon receiving the notification, either by the representative in the case of an organization or by the consignee in the case of a natural person, a recall form may need to be filled out. This recall form may allow for detailed tracking and management of the recalled items. The form may require information such as the quantity of products to be returned by the consignee, the current condition of the products, the location where the products are stored, and any relevant batch or serial numbers. Additionally, the form may ask for details about when and how the products will be returned or disposed of, depending on the nature of the recall. By collecting this information through the recall form, the company initiating the recall may effectively keep track of the progress of the product recall, ensure compliance with regulatory requirements, and maintain accurate records of the entire recall process. This data may also help in reconciling the number of products sold against those returned, allowing for a comprehensive assessment of the recall's effectiveness. Data captured through the recall form may be stored in the memory 304 of the PRMS 300 as the product available data 320 for further use in tracking the product recall process.

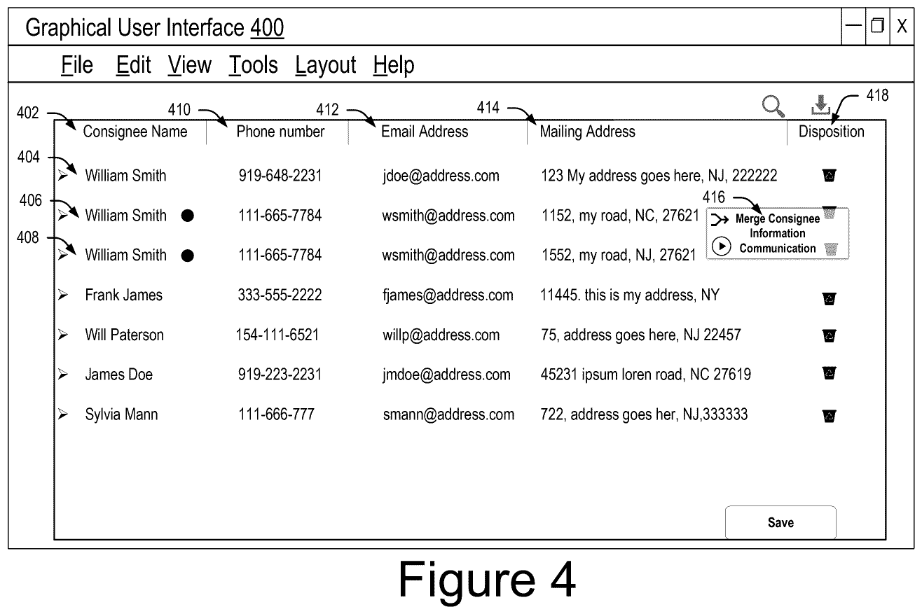

FIG. 4 is a graphical user interface (GUI) 400 of the PRMS 300, in accordance with an example implementation of the present subject matter.

As explained previously, for a plurality of consignees who have received the product to be recalled, the consignee data may include multiple records pertaining to the same consignee, which may be duplicates. These duplicate consignee records may arise due to various reasons, such as data entry errors, multiple purchases by the same consignee, or variations in the way consignee information is recorded. Similarly, if the consignee is a legal entity, then a representative may be associated with the consignee. If there is only a single representative associated with the consignee, then the notification may be sent directly to the single representative. However, in the case of multiple representatives associated with the consignee, a unique representative may need to be identified to whom the notification may be sent.

As explained in reference to FIG. 3, based on a degree of similarity between combinations of attributes of the consignee data of the consignees who have received the product identified for the recall, the AI module 324 may flag one or more consignees which may be duplicate records in the consignee data. For example, as shown in the GUI 400 of FIG. 4, based on the similarity in consignee name 402 of the consignee, the AI module 324 may flag the second and third records as potential duplicate consignee records. Given that a first consignee 404 differs from a second consignee 406 and a third consignee 408 with respect to other attributes of the consignee data, such as phone number 410, email address 412, and mailing address 414, despite the similarity in name, the first consignee 404 is identified to be different from the second consignee 406 and the third consignee 408, and out of the second consignee 406 and the third consignee 408, one may be a duplicate entry.

However, in some cases, disambiguation of the records may not be feasible based on the attributes of the consignee data. It is possible that individuals or organizations may have similar identification details. In dealing with a recall process, it may be desired to maintain a high degree of accuracy. Accordingly, the AI module 324 may be configured to seek human intervention in cases where the disambiguation may not be carried out with high degree of accuracy. In some examples, to identify the unique consignee from amongst the records with high degree of similarity, the AI module 324 may prompt a user, such as the RPM, to provide input. For this, the AI module 324 may present the flagged records to the RPM, and the RPM may select, the unique consignee.

In the foregoing example, given that data corresponding to the attributes of the consignee data for the second and third records are the same, the GUI 400 may provide a prompt 416 to merge the records pertaining to the second consignee 406 and the third consignee 408 to make it a consolidated entry. In an example, to merge the attributes of the second consignee 406 and the third consignee 408, the AI module 324 may analyze other information available in the database pertaining to the second consignee 406 and the third consignee 408. This analysis may include, but is not limited to, examining purchase history, such as dates of purchases, frequency of purchases, and types of the product purchased. The AI module 324 may also review any communication history with the consignees, including previous customer service interactions or responses to marketing campaigns. Additionally, the AI module 324 may investigate account creation dates, or other unique identifiers associated with each of the second and third consignee records to determine. Based on the analysis of these parameters, if the AI module 324 identifies that the record of the third consignee 408 is associates with additional parameters that are not already associated with the record of the second consignee 406, the AI module 324 may link these additional parameters with the record of the second consignee 406 in the database to consolidate record of the second consignee 406 and the third consignee 408. However, if the AI module 324 finds no additional parameters, a disposition prompt 418 may be provided by the AI module 324 to the RPM to delete one of the second consignee 406 and the third consignee 408 records. This ensures that the accurate and up-to-date consignee information is available in the PRMS 300 before sending out the notification regarding the recall.

Similarly, unique representatives may be identified from the representative data available in the database. Once the unique representatives are identified, for consignees who have multiple unique representatives, a single representative from amongst the multiple unique representatives is selected based on input from the RPM for the notification to be sent out to the selected representative. The enable the RPM to select the single representative corresponding to each of the consignees to whom the product identified to be recalled was delivered, the GUI 400 may further be configured to provide information usable by the RPM for selection of the single representative. Although not depicted in the example embodiment of the GUI 400 shown in FIG. 4, the GUI 400 may include pages, fields, links or pop-windows to present such information.

Examples of information usable by a user, such as the RPM for selection of a single representative from amongst multiple representatives of a consignee include details regarding the representatives' previous communications with the manufacturer. This information may enable the RPM to select the representative based on the latest representative to have communicated with the manufacturer. Similarly in another example, information usable by the RPM for selection of the single representative may be details of purchase orders of the product that the representatives have placed with the manufacturer in the past. This information may enable the RPM to select the representative based on the considerations, such as frequency, number, or monetary value of the purchase orders placed by the representatives. In other examples, the GUI 400 may be configured to display identification details, such as designation of the representatives which may be used by the RPM for selection of the single representative.

It may be noted that the UI 400 as provided in FIG. 4 is merely an example illustration and should not be considered as the only illustration. The actual UI may vary in design and functionality while still embodying the principles described herein.

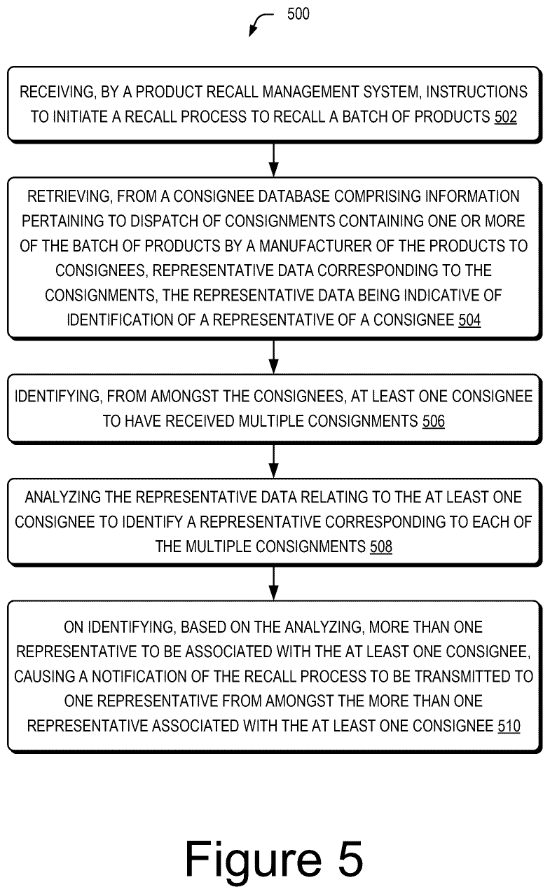

FIG. 5 illustrates a method 500 for product recall management, according to an example implementation of the present subject matter. Although the method 500 may be implemented in a variety of computer-based systems, for ease of explanation, the present description of the example method 500 for managing recall of a product is provided in reference to the above-described PRMS 102.

The order in which the method 500 is described is not intended to be construed as a limitation, and any number of the described method blocks may be combined in any order to implement the method 500, or an alternative method. Furthermore, the method 500 may be implemented by processor(s) or computing device(s) through any suitable hardware, non-transitory machine-readable instructions, or a combination thereof. The steps of the method 500 as well as other methods described herein may be performed by either a system under the instruction of machine-executable instructions stored on a non-transitory computer-readable medium or by dedicated hardware circuits, microcontrollers, or logic circuits. Herein, some examples are also intended to cover non-transitory computer-readable medium, for example, digital data storage media, which are computer readable and encode computer-executable instructions, where the instructions perform some or all the steps of the above-mentioned methods.

It may be understood that blocks of the method 500 may be performed by programmed computing devices. The blocks of the method 500 may be executed based on instructions stored in a non-transitory computer-readable medium, as will be readily understood. The non-transitory computer-readable medium may include, for example, digital memories, magnetic storage media, such as magnetic disks and magnetic tapes, hard drives, or optically readable digital data storage media.

At block 502, the instructions to initiate a recall process for a batch of products may be received, for example, by the recall execution sub-system 106 of the PRMS 102, explained in reference to the foregoing example implementations. As explained previously, these instructions may also be provided by regulatory authorities, or other authorized entities. In an example, these instructions may contain information about the specific batch of products to be recalled, including product identifiers, batch numbers, the reason for the recall, and so on.

At block 504, upon receiving the recall instructions, the information pertaining to dispatch of consignments containing one or more of the batch of products by a manufacturer of the products to consignees along with the representative data corresponding to the consignments, may be retrieved from the consignee database 108, for example, by the recall execution sub-system 106 of the PRMS 102. As explained previously, the representative data may be indicative of identification of one or more representatives of a consignee associated with the manufacturer of the products. In an example, the information pertaining to dispatch of consignments may include details, such as the quantity of products shipped, dates of shipment, and the specific consignees who received the products along with data pertaining to their representatives or addressee of the consignees to whom the consignments were delivered.

At block 506, at least one consignee that has received multiple consignments of the products identified to be recalled may be identified from amongst the consignees, for example, by the recall execution sub-system 106 of PRMS 102. This identification process may involve analyzing the consignment data to determine which consignees have received more than one shipment of the products identified to be recalled.

At block 508, the representative data relating to the identified consignees may be analysed to identify the representative corresponding to each of the multiple consignments, for example, by the recall execution sub-system 106 of PRMS 102. This analysis may involve examining various attributes of the representative data, such as names, contact information, and roles within the consignee organization. In some cases, the recall execution sub-system 106 may employ data matching algorithms to identify potential duplicates or inconsistencies in the representative data.

At block 510, on identifying, based on analyzing, more than one representative to be associated with the at least one consignee, a notification of the recall process is transmitted to one representative from amongst the more than one representative associated with the at least one consignee, for example, by the recall execution sub-system 106 of PRMS 102. As explained previously, the notification may be generated automatically by the PRMS 102 and may include pertinent details about the recall, such as the product information, reason for recall, and instructions for next steps.

Thus, the example method 500 may streamline communication in the recall process by notifying a single representative when multiple representatives are associated with a consignee. By suppressing notification to more than one representatives, the PRMS 102 may enhance overall operational efficiency and potentially reduce the complexity and resources typically associated with managing multiple representatives for each consignee during recall procedures. The streamlined communication process also leads to faster recall responses, improved accuracy in recall tracking, and ultimately, a more effective PRMS.

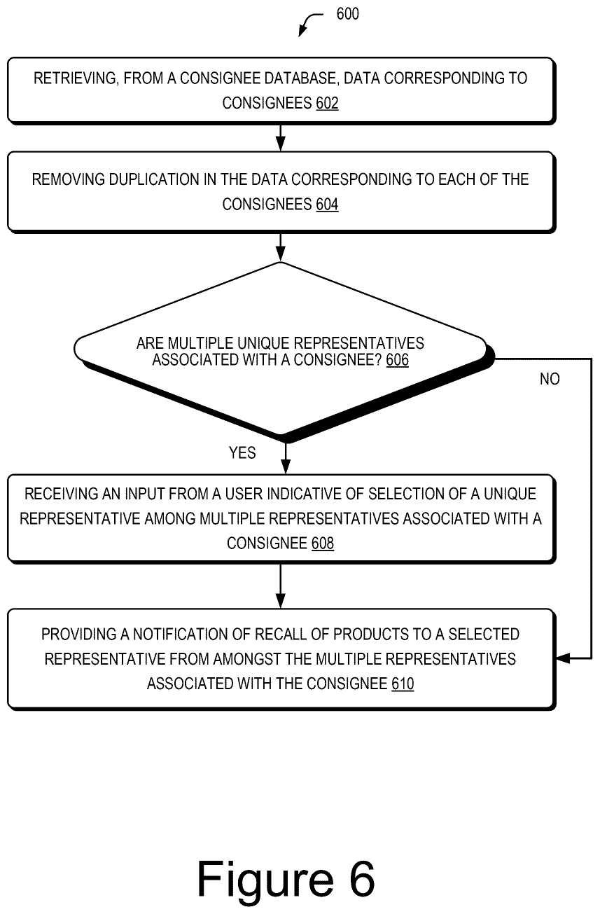

FIG. 6 illustrates a flow diagram of a process 600 for notifying a representative of a consignee in a PRMS 102 regarding recall of products, according to an example implementation of the present subject matter. The order in which the above-mentioned process 600 is described is not intended to be construed as a limitation, and some of the described process blocks may be combined in a different order to implement the process or an alternative process.

Referring to FIG. 6, at block 602, data comprising identification of consignees is retrieved, for example, by the recall execution sub-system 106 of PRMS 102. This may involve accessing the consignee database 108 to gather information about the representatives associated with each consignee. As explained previously, the representative data may include details, such as names, address, contact information, and roles of individuals or entities authorized to act on behalf of each consignee. For example, the representative data may include information, such as the first name and last name (e.g., John Doe), area code (e.g., 212 for New York City), email address (e.g., john.doe@abchospital.com), address (e.g., 123 Main St, New York, NY 10001), and phone number (e.g., (212) 555-1234) of the consignee's representative. This information may enable the PRMS 102 to accurately identify and contact the appropriate representative for each consignee during the recall process.

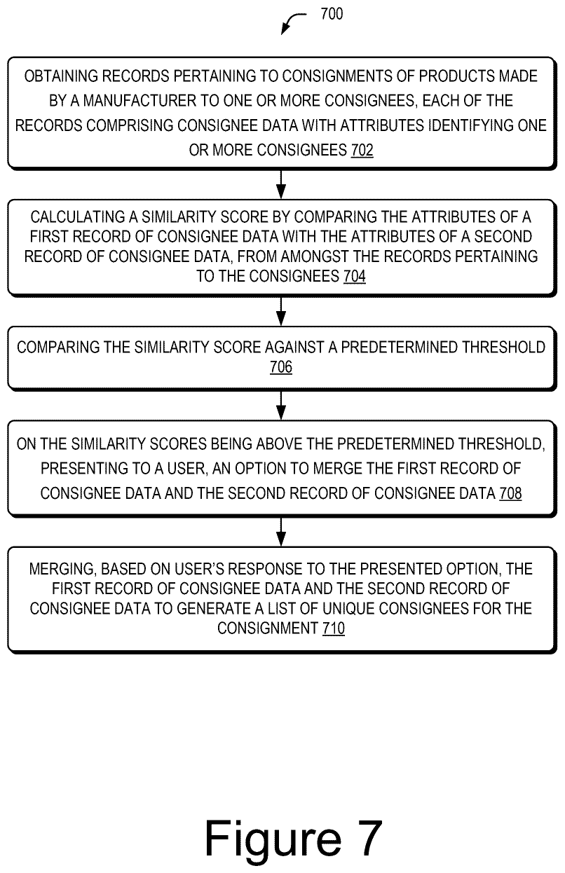

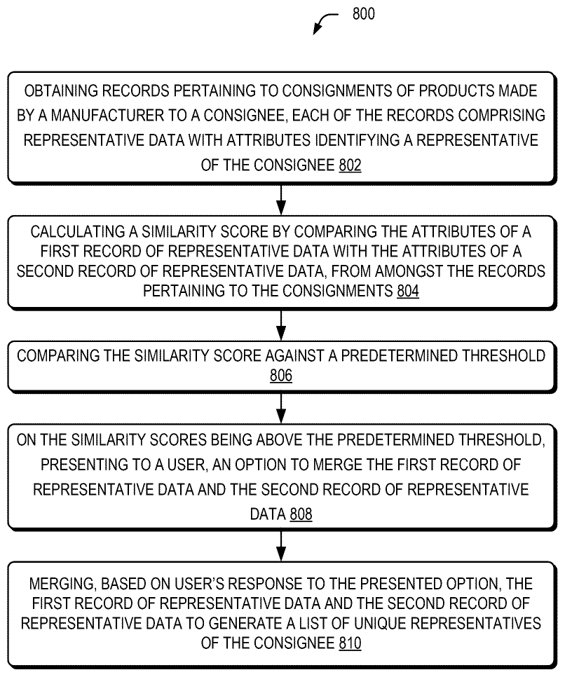

At block 604, duplication in the data corresponding to each of the consignees is removed to determine if a single or multiple unique representatives are associated with each of the respective consignees. Removing duplication in data corresponding to the consignees may comprise removing duplication in consignee data and, where applicable, removing duplication in representative data. FIG. 7 describes an example process of removing duplication in consignee data and FIG. 8 describes an example process of removing duplication and representative data.

In examples, determining if a single or multiple representatives are associated with a consignee may involve assessing a degree of similarity among the attributes in the representative data corresponding to each of the consignees. For example, identifying the similarity may involve comparing the attributes of a first representative data, i.e., data record of representative data associated with a consignee with the corresponding attributes of a second representative data of the consignee. Based on this comparison, the recall execution sub-system 106 may assess a degree of similarity between the identified attributes of the representative data to determine if they likely refer to the same individual or entity associated with the consignee. In an example, a similarity score may be calculated based on the comparison of the attributes to quantify the degree of similarity between different representative data records.

At block 606, an assessment is made as to whether the unique representatives associated with a consignee, from amongst the consignees include multiple representatives, by the recall execution sub-system 106. If it is determined that unique representatives associated with the consignee includes multiple representatives, the process 600 proceeds to block 608. However, if at block 606, it is determined that the unique representatives associated with the consignee do not include multiple representatives but a single unique representative, the process 600 directly proceeds to block 610.

At block 608, an input is received from a user indicative of selection of a unique representative among the multiple unique representatives associated with the consignee, by the recall execution sub-system 106. In an example, the user may be a product recall manager responsible for managing the recall process executing in PRMS 102. In an example, relevant information for each representative may be displayed, such as their name, role, contact details, etc., to the user. In an example, the calculated similarity score may also be presented to the user along with above attributes of the representative data to help the user in making an informed decision about which representative is most appropriate to receive the recall notification.

At block 610, a notification of the recall of products is provided to a selected representative from amongst the multiple unique representatives associated with the consignee, by the recall execution sub-system 106. As explained previously, the notification may be generated automatically by the PRMS 102 and may include pertinent details about the recall, together with instructions about the action that the selected representative needs to take further to the notification. In an example, the notification may be accompanied by an electronic form to be completed by the selected representatives on behalf of their respective consignees. The form may include fields for confirming receipt of the recall notification, specifying the quantity of recalled products in the consignee's possession, detailing any products that have already been distributed or used, and providing a timeline for returning the recalled items.

FIG. 7 illustrates a flow diagram of a process 700 for selecting unique consignees amongst the multiple consignees in a PRMS 102, according to an example implementation of the present subject matter. The order in which the above-mentioned process 700 is described is not intended to be construed as a limitation, and some of the described process blocks may be combined in a different order to implement the process or an alternative process.

Referring to FIG. 7, at block 702, records pertaining to consignments of products made by a manufacturer of the products to one or more consignees is obtained, for example, by the recall execution sub-system 106, where each of the records comprises consignee data with attributes identifying a consignee of the consignment. In an example, the consignee attributes may include, but are not limited to, name, and contact information of a consignee.

At block 704, a similarity score is calculated by comparing the attributes of a first record of consignee data with the attributes of a second record of consignee data, from amongst the records pertaining to the consignments, for example, by the recall execution sub-system 106. In an example, when comparing attributes of the consignee data, a similarity score, for example, on a scale from 0 to 1 may be assigned, with 1 indicating an exact match. In an example, the consignee attributes to be considered for the similarity comparison may be predefined, for example, based on input from a recall process manager (RPM) who may be a user authorized to process the recall request for the product at the recall execution sub-system 106 of PRMS 102.

At block 706, the calculated similarity score is compared against a predetermined threshold, for example, by the recall execution sub-system 106, to determine if the first record and the second record of consignee data are potentially the same consignee. In an example, if the similarity score exceeds the predetermined threshold, the records may be treated as similar consignees. Conversely, if the similarity score falls below the threshold, the records may be considered too pertain to distinct consignees. In an example, the predetermined threshold may be set based on various factors, such as the desired level of accuracy in identifying unique consignees or the specific requirements of the recall process. In some implementations, the threshold may be adjustable by authorized users of the PRMS 102.

At block 708, on the similarity scores being above the predetermined threshold, an option is presented to the user, for example, by the recall execution sub-system 106 of the PRMS 102, to merge the first record of consignee data and the second record of consignee data. This merging process may involve combining the information from both records into a single entry that accurately represents the unique consignee.

At block 710, based on user's response to the presented option, the first record of consignee data and the second record of consignee data are merged to generate a list of unique consignees, for example, by the recall execution sub-system 106 of the PRMS 102. In an example, the merging may involve combining the most accurate and up-to-date information from both records into a single, comprehensive entry. The merged record may include the most complete name, the most recent contact information, and any additional relevant details from both original records. In an example, the data corresponding to the attributes of consignee data available in the duplicate record that are not available in the unique record may be merged into the unique record.

As will be understood, all records of consignee data in the consignee database 108 are compared and treated in a manner similar to that explained for the first record and the second record of consignee data to remove duplicate records. Once the merge is complete, the recall execution sub-system 106 of the PRMS 102 may update the consignee database 108 with the newly merged record, effectively reducing the number of duplicate records and refining the consignee data.

FIG. 8 illustrates a flow diagram of a process 800 for selecting unique representatives amongst the multiple representatives for a consignee in a PRMS 102, according to an example implementation of the present subject matter. The order in which the above-mentioned process 800 is described is not intended to be construed as a limitation, and some of the described process blocks may be combined in a different order to implement the process or an alternative process.

Referring to FIG. 8, at block 802, records pertaining to consignments of products made by a manufacturer of the products to a consignee are obtained, for example, by the recall execution sub-system 106, where each of the records comprises representative data with attributes identifying a representative of consignee. The present method describes the treatment of representative data corresponding to one consignee merely for the sake of simplicity. As will be apparent, the same method may be extended to two representative data corresponding to all consignees that may be relevant for I've given recall process. In an example, the representative attributes may include, but are not limited to, name, designation, contact information, department, shift timings, frequency of interaction with the product to be recalled, level of authority within the organization, and duration of employment with the unique consignee. The step 802 is similar to steps 504, and 602 explained in reference to FIGS. 5 and 6.

At block 804, a similarity score is calculated by comparing the attributes of a first record of representative data with the attributes of a second record of representative data, from amongst the records pertaining to the consignments, for example, by the recall execution sub-system 106. The similarity score is indicative of how close the first record and the second record are to each other and in turn, indicates if the two records belong to the same individual representing the consignee. Various techniques, such as those explained in the foregoing description, may be employed to assess the similarity between the attributes of the two records of data.

At block 806, the calculated similarity score is compared against a predetermined threshold, for example, by the recall execution sub-system 106, to determine if the first record and the second record of representative data are potentially the same representative. The predetermined threshold may be configurable and may be defined based on various factors, such as the desired level of accuracy in identifying unique representatives. If the similarity score falls below the threshold, the record may be treated as distinct representatives. Conversely, if the similarity score exceeds the predetermined threshold, the records may be treated to relate to the same individual, meaning that one of the records is a redundant or duplicate entry. If the similarity score is above the predetermined threshold, an option is presented to the user, for removal of the redundant or duplicate entry. Accordingly, at block 908, an option is presented to the user, for example, by the recall execution sub-system 106 of the PRMS 102, to merge the first record of representative data and the second record of representative data. This merging process may involve combining the information from both records into a single, comprehensive entry that accurately represents the unique representative.

At block 810, based on the user's response to the presented option, the first record of representative data and the second record of representative data are merged to generate a list of unique representatives of the consignee, for example, by the recall execution sub-system 106 of the PRMS 102. Numerous natural language processing techniques may be applied for merging two or more records that pertain to the same representative. Based on a comparison of each of the records of representative data in the database with one another, an updated list of unique representatives is generated for the recall process, ensuring that recall notifications are directed to the most appropriate and up-to-date points of contact.

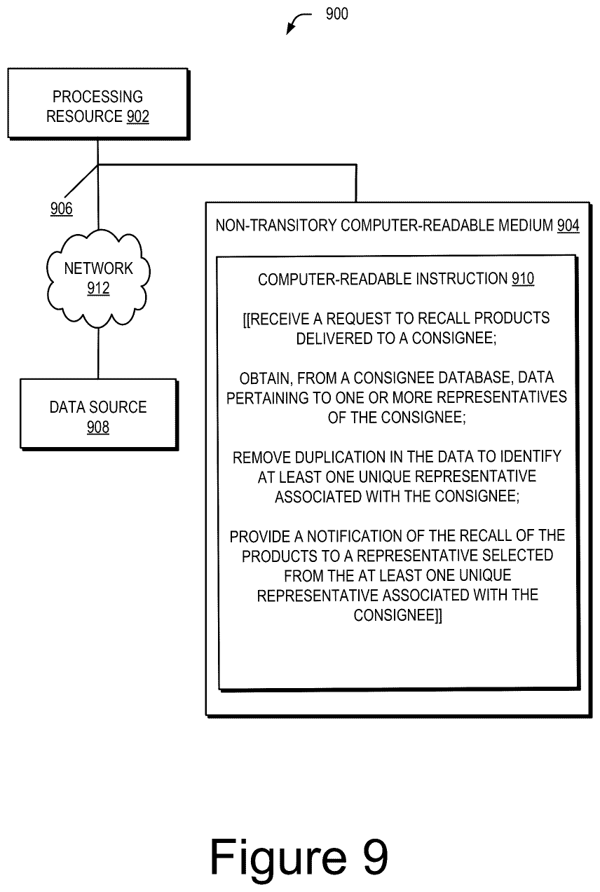

FIG. 9 illustrates a computing environment 900 for managing product recalls, according to an example implementation of the present subject matter. The computing environment 900 includes a processing resource 902 communicatively coupled to a non-transitory computer-readable medium 904 through a communication link 906. In an example, the processing resource 902 may be the processor of the PRMS 102, which fetches and executes computer-readable instructions from the non-transitory computer-readable medium 904.

The non-transitory computer-readable medium 904 may be, for example, an internal memory device or an external memory device. In an example implementation, the communication link 906 may be a direct communication link, such as any memory read/write interface. In another example implementation, the communication link 906 may be an indirect communication link, such as a network interface. In such a case, the processing resource 902 may access the non-transitory computer-readable medium 904 through a network 912. The network 912 may be a single network or a combination of multiple networks and may use a variety of different communication protocols.

The processing resource 902 and the non-transitory computer-readable medium 904 may also be communicatively coupled to data sources 908. The data source(s) 908 may be used to store data corresponding to the product recall management process, for example.

In an example implementation, the non-transitory computer-readable medium 904 comprises executable instructions 910 for enabling the management of product recalls.

According to an example implementation of the present subject matter, the instructions 910 may cause the processing resource 902 to receive a request to recall products delivered to a consignee. In example, the request to recall products may originate from various sources, including regulatory authorities or other authorized users of the PRMS 102. As explained previously, the recall request includes details about the products to be recalled, such as unique product identifiers and batch numbers of the products. In an example, the recall request may also comprise the reason for the recall, which could range from manufacturing defects to potential safety hazards.

The instructions 910 may cause the processing resource 902 to obtain data pertaining to one or more representatives of the consignee from a consignee database 108, such as the previously discussed consignee database 108. As explained previously, the representative data may include various attributes, such as names, contact information, addresses, emails, and designations of the representatives of the consignee. These attributes serve to identify and provide information about the one or more representatives associated with the consignee.

The instructions 910 may cause the processing resource 902 to remove duplication in the data to identify at least one unique representative associated with the consignee. As explained previously, identifying unique representatives entails a process of removal of multiple records of the same individual or entity from the data, for instance, by an AI module trained to remove duplication in the data. The AI module may utilize machine learning techniques such as clustering algorithms, decision trees, or neural networks to analyse patterns in the representative data to detect potential duplicates.

In an example implementation, the AI module may be trained based on historical data relating to receipt of orders for the products and dispatch of consignments of the products to a plurality of consignees. The instructions may be executable by the processing resource to generate training data to train the AI module based on such historical data. This training data may include past instances of duplicate records, successful deduplication cases, and examples of representative data variations that refer to the same individual or entity. By learning from this historical data, the AI module acquires the ability to recognize patterns and relationships in the representative data, leading to identification of unique representatives.

Based on identification of at least one unique representative associated with the consignee, the instructions 910 may be executable to cause the processing resource 902 to provide a notification of the recall of the products to a representative selected from the at least one unique representative. The selection of the representative may be made by a user.

To enable the user to make the selection, the instructions may be executable by the processing resource 902 to display historical data relating to the consignee as a prompt for the user input. In an example, the historical data may comprise various types of information that can aid the user in making an informed decision about which representative to select. For example, the historical data may include the number of past orders placed by the consignee, the frequency of these orders, and the total volume or monetary value of products ordered over a specific time period. In an example, the information may also comprise the designations or roles of the representatives within the consignee's organization, such as procurement officer, quality control manager, or department head.

The instructions may be further executable to receive a user input to suppress the notification of the recall of the products to remain the at least one unique representative associated with the consignee.

In accordance with one example implementation of the present subject matter. The instructions may further be executable by the processing resource to store an identification of the representative selected from the at least one unique representative in the consignee database. In an example, the stored identification of the selected representative may be usable in future recall processes.

In examples, the identification of the selected representative may also serve as training data for the AI module, for instance, the AI module may identify patterns in selection of the representatives based on selections made by users over a period of time. The AI module may analyze patterns in the stored selections, such as the frequency with which certain representatives are chosen, their roles within the organization, and their effectiveness in handling past recalls. This may enable the AI module to improve its decision-making capabilities over time, potentially leading to more efficient and targeted recall communications in the future.

Thus, the methods and systems of the present subject matter streamline product recall processes by identifying a single unique representative when multiple representatives are associated with a consignee. This targeted approach expedites communication, reduces miscommunication risks, and minimizes potential oversights. By enhancing efficiency and improving consignee information accuracy, the PRMS mitigates errors and decreases the likelihood of overlooked notifications in recall management.

While specific implementations of the product recall management system have been discussed, it is to be understood that the appended claims are not necessarily limited to the specific features or methods described. Rather, the specific features and methods are disclosed as example implementations for enhancing the precision and effectiveness of product recall processes across various industries.

1. A product recall management system, comprising:
a consignee database comprising representative data indicative of identification of one or more representatives of a consignee associated with a manufacturer of a product; and
a recall execution sub-system configured to execute a workflow for a process of executing recall of the product, wherein to initiate the process of executing recall of the product, the recall execution sub-system is to:
determine, based on representative data retrieved from the consignee database, if a single or multiple representatives are associated with the consignee;
on identifying a single representative to be associated with the consignee, delivering a notification of recall of the product to the single representative; and
on identifying multiple representatives to be associated with the consignee, select one representative from amongst the multiple representatives and deliver the notification of the recall of the product to the one representative.

2. The product recall management system of claim 1, further comprising a recall decision sub-system configured to execute a workflow for a process of deciding recall of the product, wherein the recall execution sub-system is to provide an indication of the one representative selected from amongst the multiple representatives to the recall decision sub-system.

3. The product recall management system of claim 1, wherein the consignee database further comprises consignee data indicative of identification of consignees associated with the manufacturer, and wherein the recall execution sub-system is to determine, based on the consignee data, one or more unique consignees from amongst the consignees associated with the manufacturer.

4. The product recall management system of claim 1, wherein the recall execution sub-system implements an AI module to determine if the single or multiple representatives are associated with the consignee, and wherein the AI module is to remove duplication in the representative data corresponding to the consignee to determine if the single or multiple representatives are associated with the consignee.

5. The product recall management system of claim 4, wherein the AI module is to determine a degree of similarities in attributes of the representative data to remove the duplication.

6. The product recall management system of claim 1, wherein the recall execution sub-system is to select the one representative from amongst the multiple representatives based on an input from an authorized user of the product recall management system.

7. The product recall management system of claim 6, wherein the recall execution sub-system is to provide to the authorized user, historical data relating to receipt of orders and dispatch of consignments to the consignee to prompt the authorized user for the input.

8. A method comprising:
receiving, by a product recall management system, instructions to initiate a recall process to recall a batch of products;
retrieving, from a consignee database comprising information pertaining to dispatch of consignments containing one or more of the batch of products by a manufacturer of the products to consignees, representative data corresponding to the consignments, the representative data being indicative of identification of a representative of a consignee;
identifying, from amongst the consignees, at least one consignee to have received multiple consignments;
analyzing the representative data relating to the at least one consignee to identify a representative corresponding to each of the multiple consignments; and
on identifying, based on the analyzing, more than one representative to be associated with the at least one consignee, causing a notification of the recall process to be transmitted to one representative from amongst the more than one representative associated with the at least one consignee.

9. The method of claim 8, wherein analyzing the representative data relating to the at least one consignee comprises determining if the representative corresponding to each of the multiple consignments is unique, based on a degree of similarities in attributes of the representative data.

10. The method of claim 8, further comprising training an AI module to determine, based on the representative data, if the representative corresponding to each of the multiple consignments is unique.

11. The method of claim 8, further comprising:
on identifying more than one representative corresponding to the at least one consignee, selecting the one representative from amongst the more than one representative, based on historical data relating to dispatch of the consignments to the at least one consignee.

12. The method of claim 8, further comprising:
on identifying more than one representative corresponding to the at least one consignee, selecting the one representative from amongst the more than one representative, based on a user input.

13. The method of claim 8, wherein the representative data comprises a name of a representative, an address of the representative, contact information of the representative, a designation of the representative as assigned by a corresponding consignee, or a combination thereof.

14. A non-transitory computer-readable medium comprising instructions executable by a processing resource to:
receive a request to recall products delivered to a consignee;
obtain, from a consignee database, data pertaining to one or more representatives of the consignee;
remove duplication in the data to identify at least one unique representative associated with the consignee; and
provide a notification of the recall of the products to a representative selected from the at least one unique representative associated with the consignee.

15. The non-transitory computer-readable medium as claimed in claim 14, further comprising instructions executable by the processing resource to receive a user input to select the representative from the at least one unique representative associated with the consignee.

16. The non-transitory computer-readable medium as claimed in claim 15, further comprising instructions executable by the processing resource to display historical data relating to the consignee as a prompt for the user input.

17. The non-transitory computer-readable medium as claimed in claim 14, further comprising instructions executable by the processing resource to receive a user input to suppress the notification of the recall of the products to remaining of the at least one unique representative associated with the consignee.

18. The non-transitory computer-readable medium as claimed in claim 14, further comprising instructions executable by the processing resource to store in the consignee database an identification of the representative selected from the at least one unique representative associated with the consignee.

19. The non-transitory computer-readable medium as claimed in claim 14, further comprising instructions executable by the processing resource to train an AI module to remove duplication in the data to identify the at least one unique representative associated with the consignee.

20. The non-transitory computer-readable medium as claimed in claim 19, further comprising instructions executable by the processing resource to generate training data to train the AI module based on historical data relating to receipt of orders for the products and dispatch of consignments of the products to a plurality of consignees.
